(19) United States
(12) Patent Application Publication
(10) Pub. No.: US 2017/0267325 A1
(43) Pub. Date: Sep. 21, 2017

(54) BALLAST WATER CIRCULATION SYSTEM, CONTROL UNIT, AND RELATED METHOD

(71) Applicant: Bawat A/S, Hørsholm (DK)

(72) Inventors: Jan Stumpe Hummer, Klampenborg (DK); Ole Lüthcke Christensen, Kgs. Lyngby (DK)

(21) Appl. No.: 15/529,374

(22) PCT Filed: Nov. 25, 2015
(86) PCT No.: PCT/EP2015/077686

§ 371 Date: May 24, 2017

(30) Foreign Application Priority Data
Nov. 28, 2014 (DK) PA201470751

(51) Int. Cl. B63J 4/00; C02F 1/00

(52) U.S. Cl. CPC B63J 4/002; C02F 1/008; B63B 13/00

(57) ABSTRACT

A control unit, a circulation system, and a method for handling ballast water of one or more ballast tanks. The circulation system includes a control unit; a pipe structure having a first system inlet and a first system outlet; and a pump unit for pumping ballast water between the first system inlet and the first system outlet, the pump unit being connected to the control unit. The control unit is configured to: obtain a volume parameter indicative of pumped volume; determine if a pump criterion is fulfilled, the pump criterion being based on the volume parameter; and operate the pump unit based on whether the pump criterion is fulfilled or not.

The present disclosure relates to a system and method for handling and/or treating, such as cleaning, decontaminating, sanitizing, and/or sterilizing, ballast water, such as ballast water in ballast tanks onboard vessels and other offshore constructions. Furthermore the present disclosure relates to a control unit for controlling such a system and/or parts of such a system

### BACKGROUND

To uphold the stability of a ship independently of it carrying cargo or not, ships are provided with tanks that can be filled or emptied depending on the nature of the cargo. Such tanks are designated ballast tanks, and the water charged into them is designated ballast water.

When an empty ship or a ship partially carrying cargo leaves a port, ballast water has therefore been charged into the ballast tanks to uphold stability and to adjust the buoyancy of the ship. Almost always such ballast water will contain live organisms, such as plankton, algae, etc. When the ship arrives at its destination, and when the ship is once again to take on a cargo, the ballast water is discharged back into the sea.

The discharge of ballast water may thus potentially introduce invasive species to the marine environment in the destination port, which means that the live organisms are moved from their natural habitat to a new biosphere. Those live organisms that are indigenous to another part of the world may be a threat to the local marine life and are therefore designated “biological pollution”. Every year, major tank vessels move billions of cubic meters of water with live organisms from one part of the world to another, and the tank vessels are thereby contributing factors in the introduction of hundreds of invasive marine species to new environments which is considered to be one of the world's largest environmental issues.

Now, specific requirements have been drawn up by the International Maritime Organization (IMO) in respect of how few live organisms are allowed in the pumped-out ballast water, and the present disclosure provides means towards complying with those requirements.

### SUMMARY

There is a need for a system and related method which provide an effective and reliable method for handling and/or treating ballast water to reduce biological pollution.

Accordingly, a circulation system for handling ballast water of one or more ballast tanks, e.g. during treatment of the ballast water, is provided. The circulation system comprises a control unit, a pipe structure and a pump unit. The pipe structure has a first system inlet and a first system outlet. The first system inlet is configured for fluid communication with a tank outlet of the one or more ballast tanks for supplying ballast water to the circulation system. The first system outlet is configured for fluid communication with a tank inlet of the one or more ballast tanks for supplying ballast water to the one or more ballast tanks. The pump unit is configured for pumping ballast water between the first system inlet and the first system outlet. The pump unit is connected to the control unit. The control unit is configured to: obtain a volume parameter indicative of pumped volume; determine if a pump criterion is fulfilled, wherein the pump criterion is based on the volume parameter; and operate the pump unit based on whether the pump criterion is fulfilled or not.

Also disclosed is a ballast water system comprising a circulation system, such as the disclosed circulation system, and a ballast tank. The ballast tank has a tank inlet and a tank outlet. The tank inlet is at the lower part of the ballast tank and the tank outlet is at the upper part of the ballast tank. A first system inlet of the circulation system is coupled to the tank outlet and a first system outlet of the circulation system is coupled to the tank inlet.

Also disclosed is a method for handling ballast water of one or more ballast tanks, e.g. during treatment of the ballast water. The method comprises: pumping ballast water in a pipe structure between a tank outlet and a tank inlet with a pump unit; obtaining a volume parameter indicative of pumped volume; determining if a pump criterion is fulfilled, wherein the pump criterion is based on the volume parameter; and operating the pump unit based on whether the pump criterion is fulfilled or not.

Also disclosed is a control unit for a circulation system comprising a pump unit pumping ballast water in a pipe structure between a tank outlet and a tank inlet. The circulation system is configured for handling ballast water of one or more ballast tanks e.g. during treatment of the ballast water. The control unit is configured to: obtain a volume parameter indicative of pumped volume; determine if a pump criterion is fulfilled, wherein the pump criterion is based on the volume parameter; and operate the pump unit based on whether the pump criterion is fulfilled or not. The control unit may be the control unit of the disclosed circulation system.

The system and/or method may be configured to or combined with treatment of the ballast water, e.g. treating the ballast water in circulation and/or providing a chemical compound to the ballast tank, thereby reducing or effectively eliminating the risk of discharging ballast water containing living organisms. Furthermore, the disclosure provides optimization of ballast water treatment which reduces costs while maintaining that ballast water is treated sufficiently to meet selected requirements.

Handling of ballast water may be combined with treatment of ballast water, e.g. handling of ballast water may comprise treatment of ballast water. Treatment of ballast water may be provided to meet specific criteria concerning living organism content, e.g. treatment of ballast water may aim at reducing and/or eliminating living organisms in the ballast water and/or treatment of ballast water may aim at reducing oxygen content and/or increasing carbondioxide and/or nitrogen content in the ballast water, such as dissolved oxygen in the ballast water. For example, the ballast water may be considered to be treated if the number of living organisms per volume is less than a threshold and/or if the oxygen content in the ballast water is below another threshold.

It is desired to control the handling and/or treatment of ballast water from easy accessible parameters. Hence, the handling and/or treatment of ballast water may be controlled using parameters such as pumped volume and/or gas, such as oxygen content in the ballast water.

It is a further advantage of the present disclosure that an effective and reliable system, control unit and method for handling ballast water are provided. The disclosure provides for handling ballast water with reduced energy consumption, e.g. by reusing energy which is otherwise wasted and/or effectively reducing energy consumption when specific parameters have been met.

### BRIEF DESCRIPTION OF THE DRAWINGS

The above and other features and advantages of the present invention will become readily apparent to those skilled in the art by the following detailed description of exemplary embodiments thereof with reference to the attached drawings, in which:

FIG. 1 schematically illustrates an exemplary ballast water system,

FIG. 2 schematically illustrates an exemplary circulation system for handling ballast water,

FIG. 3 schematically illustrates an exemplary sensor unit,

FIG. 4 is a flow chart of an exemplary method for handling ballast water, and

FIG. 5 is a flow chart of an exemplary method for handling ballast water.

### DETAILED DESCRIPTION

Vessels and other offshore constructions may comprise one or more ballast tanks. The circulation system is configured for handling ballast water of one or more ballast tanks. The one or more ballast tanks may comprise a ballast tank. The ballast tank may be one of a plurality of ballast tanks.

A ballast tank may be divided into a plurality of sections and/or a plurality of compartments. The plurality of ballast tanks may comprise one or more ballast tanks with a first number of sections and/or compartments. Additionally the plurality of ballast tanks may comprise one or more ballast tanks with a second number of sections and/or compartments. For example, a ballast tank may comprise a plurality of sections, such as at least a first section and a second section of a ballast tank, provided transversely along the longitudinal extension of a ship/vessel. Two adjacent sections of a ballast tank are separated by a section wall. A web frame may constitue a section wall. Adjacent sections may be in fluid connection via one or more openings in the section wall. A section may comprise a plurality of compartments, e.g. transverse compartments. Compartments may be separated by a compartment wall, wherein the compartment wall between adjacent compartments may comprise one or more openings, e.g. a first center opening and/or one or more corner openings.

The pipe structure of the circulation system has a system inlet, such as the first system inlet. The pipe structure may have a plurality of system inlets including the first system inlet and a second system inlet. A plurality of system inlets and/or a plurality of tank outlets facilitate a more effective ballast water circulation, for example at different ballast water levels in a ballast tank. In this regard, the system may be configured to utilize the uppermost tank outlet and/or system inlet, which is below the ballast water level in the ballast tank. A system inlet, such as the first system inlet, is configured for fluid communication with one or more tank outlets of the one or more ballast tanks.

The one or more ballast tanks may have a plurality of tank outlets, e.g. tank outlets of different ballast tanks and/or sections and/or compartments of the one or more ballast tanks. A first tank outlet may be connected to a first compartment of the one or more ballast tanks, and/or a second tank outlet may be connected to a second compartment of the one or more ballast tanks. The first system inlet may be configured for fluid communication with the first tank outlet. The second system inlet may be configured for fluid communication with the second tank outlet.

The pipe structure of the circulation system has a system outlet, such as the first system outlet. The pipe structure may have a plurality of system outlets including the first system outlet and a second system outlet. A plurality of system outlets may facilitate a more effective ballast water circulation, for example at different ballast water levels in a ballast tank.

The one or more ballast tanks may have a plurality of tank inlets, e.g. tank inlets of different ballast tanks and/or sections and/or compartments of the one or more ballast tanks. A first tank inlet may be connected to the first and/or a third compartment of the one or more ballast tanks, and/or a second tank inlet may be connected to the first and/or a fourth compartment of the one or more ballast tanks. The first system outlet may be configured for fluid communication with the first tank inlet. The second system outlet may be configured for fluid communication with the second tank inlet.

A system inlet and/or a plurality of system inlets, such as the first system inlet and/or the second system inlet, is configured for supplying ballast water to the circulation system, such as supplying ballast water to the circulation system from the one or more ballast tanks.

A system outlet and/or a plurality of system outlets, such as the first system outlet and/or the second system outlet, is configured for supplying ballast water to the one or more ballast tanks, such as supplying ballast water to the one or more ballast tanks from the circulation system.

The pump unit is configured for pumping ballast water between a system inlet and/or a plurality of system inlets, such as the first system inlet and/or the second system inlet, and a system outlet and/or a plurality of system outlets, such as the first system outlet and/or the second system outlet. The pump unit may be a circulation pump. The pump unit may for example have a pump capacity of up to 500 m3 per hour or more. In exemplary systems, the pump unit may have a pump capacity in the range from 100 to 300 m3 per hour. The pump unit may be operated to achieve a specific pump speed, e.g. 50 m3 per hour, 100 m3 per hour, 200 m3 per hour, 400 m3 per hour, or 500 m3 per hour.

The control unit is configured to control operation of the circulation system and elements/units thereof. The control unit comprises a processing unit and an interface, e.g. including a user interface. A volume parameter indicative of pumped volume, such as pumped ballast water volume, is obtained. Pumped volume may be ballast water volume through the circulation system, ballast water volume through the pipe structure, ballast water volume through the first system inlet, ballast water volume through the first system outlet, and/or ballast water volume through the pump unit. The control unit may be configured to obtain the volume parameter indicative of pumped volume. The volume parameter indicative of pumped volume may comprise pump capacity and/or pump time.

The volume parameter may be obtained by integrating over a flow parameter indicative of ballast water flow, e.g. ballast water flow through the circulation system, ballast water flow through the pipe structure, ballast water flow through the first system inlet, ballast water flow through the first system outlet, and/or ballast water flow through the pump unit. The control unit may be configured to obtain the flow parameter indicative of ballast water flow. The control unit may be configured to obtain the volume parameter indicative of pumped volume by integrating over the ballast water flow indicated by the obtained flow parameter.

In the system and/or method it is determined if a pump criterion is fulfilled, i.e. a pump criterion is evaluated. The pump criterion is based on the volume parameter. The control unit may determine if the pump criterion is fulfilled. The pump criterion may comprise one or more subcriteria, such as a first subcriterion and/or a second sub-criterion. The pump criterion may be fulfilled if one or more subcriteria are fulfilled. For example, fulfilment of a first sub-criterion, e.g. based on the volume parameter, may be indicative of a possible reduction in pump speed. Further, fulfilment of a second sub-criterion, e.g. based on a sensor output may be indicative of a need for continued pumping. The processing unit may be configured to apply different sub-criteria of the pump criterion depending on the ballast water system configuration or operating parameters thereof. Determining if the pump criterion is fulfilled may comprise, at least in a first subcriterion, comparing pumped volume and a threshold value, such as a volume threshold value. The threshold value may be a function of ballast water volume in the one or more ballast tanks. For example, the threshold value may be given as a multiplication factor times ballast water volume in the one or more ballast tanks. The multiplication factor may be between 1 and 10. The threshold value may be between 1 to 10 times ballast water volume in the one or more ballast tanks.

The pump criterion may be based on ballast water volume or a parameter indicative thereof, such as ballast water volume of the one or more ballast tanks, or number of filled sections and/or compartments. The method may comprise obtaining ballast water volume data indicative of ballast water volume in the one or more ballast tanks. The control unit may be configured to obtain ballast water volume data indicative of ballast water volume in the one or more ballast tanks. Ballast water volume data indicative of ballast water volume may be obtained from a user interface or control panel where an operator enters ballast water volume data indicative of ballast water volume. Alternatively or additionally, ballast water volume data indicative of ballast water volume may be obtained from one or more sensors in the one or more ballast tanks, and/or from a central vessel computer.

The pump unit is operated based on whether the pump criterion is fulfilled or not. The control unit is configured to operate the pump unit based on whether the pump criterion is fulfilled or not. The control unit may be configured to reduce a pump speed, such as the pump speed of the pump unit, when the pump criterion is fulfilled. For example, the pump speed may be reduced if the pump criterion or at least a first subcriterion thereof is fulfilled. For example, the pump speed may be reduced to less than 50%, less than 20%, less than 10%, less than 5%, or to 0% of pump capacity of the pump unit, if the pump criterion is fulfilled.

Alternatively or additionally, the pump speed may be maintained and/or increased if the pump criterion is not fulfilled. For example, the pump speed may be increased and/or set to 100% of pump capacity of the pump unit, if the pump criterion is not fulfilled. The control unit may be configured to maintain and/or increase a pump speed, such as the pump speed of the pump unit, when the pump criterion is not fulfilled.

The control unit is configured to operate the pump unit. The pump unit may be configured to provide a flow depending on a control signal from the control unit. The control unit may obtain the volume parameter indicative of pumped volume by operating the pump unit to provide a selected flow. Thus, the pumped volume may be obtained by integrating over the flow. Alternatively or additionally, the control unit may obtain the volume parameter from one or more elements, e.g. volume or flow sensor(s) of the circulation system.

The circulation system may comprise one or more sensor units. A sensor unit may be connected to the control unit for providing a sensor output to the control unit. The volume parameter indicative of pumped volume may be based on the sensor output. A sensor unit may comprise a plurality of sensors. A sensor unit and/or one or more sensors of the sensor unit may be integrated parts of an element of the circulation system, such as the pump unit.

A first sensor unit may comprise a flow sensor measuring ballast water flow through the circulation system. The sensor output may be indicative of ballast water flow. The first sensor unit may be positioned in the pipe structure between the first system inlet and the first system outlet. The flow sensor may be an integrated sensor of the pump unit.

The first sensor unit and/or a second sensor unit may comprise a volume sensor measuring ballast water volume through the circulation system. The sensor output may be indicative of pumped ballast water volume. The second sensor unit may be positioned in the pipe structure between the first system inlet and the first system outlet. The volume sensor may be an integrated sensor of the pump unit.

A sensor unit, such as the first sensor unit or a second sensor unit, may comprise a gas sensor configured for measuring or obtaining gas content in the ballast water. The gas sensor may be configured for measuring or obtaining the content of one or more of oxygen, nitrogen or carbondioxide in the ballast water. The sensor output may be indicative of gas content and/or content of specific gasses in the ballast water. The gas sensor may be positioned in the pipe structure between the first system inlet and the first system outlet. The gas sensor may be an integrated sensor of the pump unit.

A sensor unit, such as the first sensor unit or the second sensor unit or a third sensor unit, may comprise a sensor configured for measuring or obtaining micro-organism activity in the ballast water.

The circulation system may comprise a water treatment unit for treating ballast water between the first system inlet and the first system outlet. The water treatment unit may comprise a heat exchanger configured to heat the ballast water. The heat exchanger may be configured to treat ballast water according to a set of operating parameters. The operating parameters may include a first operating parameter. The first operating parameter may be temperature. The first operating parameter may be a temperature in the range from 65° C. to 85° C., such as from 70° C. to 75° C. An exemplary temperature is 72° C. The operating parameters may include a second operating parameter. The second operating parameter may be holding time. Holding time may be time of treatment. The second operating parameter may be a holding time of at least 30 seconds, such as in the range from 30 seconds to 120 seconds. Exemplary holding times are in the range from 45 to 90 seconds, such as 60 or 75 seconds.

The heat exchanger may for example be configured to heat the ballast water to a first temperature (first operating parameter), e.g. 72° C., for at least a first period of time (second operating parameter), e.g. at least 30 seconds, such as 75 seconds. The heat exchanger may be configured to heat the ballast water to kill living organisms in the ballast water.

The water treatment unit may comprise a chemical supply, wherein a chemical substance, such as chlorine or a composition comprising an active reagent, e.g. chlorine, is added to the ballast water. The chemical substance added to the ballast water is adapted to kill living organisms in the ballast water. The water treatment unit may comprise a radiation source, such as a UV source configured for UV treatment of ballast water.

The circulation system may comprise a fluid source having a fluid outlet connected to a fluid inlet of the pipe structure. The fluid source may add fluid, such as a gas, and/or a liquid and/or a combination of a gas and a liquid, to the ballast water in the pipe structure. For example, addition of gas, such as nitrogen, may facilitate depletion of oxygen in the ballast water and/or facilitate flow through the ballast water tanks. The fluid source may add fluid to the ballast water under pressure. Addition of fluid, e.g. nitrogen, to the ballast water under pressure may facilitate that the added fluid is dissolved in the ballast water in the pipe system. Subsequently, when the ballast water with the added fluid enters the ballast tank, the pressure drops leading to the formation of bubbles inside the ballast tank. This effect may provide a stirring or mixing effect inside the ballast tank. Thereby, the ballast water, at least within a compartment, may be regarded as homogenous, or substantially homogenous, in the one or more ballast tanks and/or in each compartment of the one or more ballast tanks.

The fluid inlet of the pipe structure may be positioned downstream the pump unit. Positioning the fluid inlet of the pipe structure downstream the pump unit may eliminate or reduce the risk of gas and/or bubbles in the pump unit, e.g. leading to malfunction or reduced effectivity of the pump unit.

The fluid source may have a fluid inlet connected to a fluid outlet of the pipe structure. Hence, a fraction, e.g. 5%, of the ballast water in the pipe structure may flow through the fluid source, and fluid, such as a gas, a liquid, and/or a combination of gas and liquid may be added to the fraction of ballast water flowing through the fluid source. The fluid outlet of the pipe structure may be positioned downstream the pump unit.

The fluid source may be connected to the control unit. The control unit may be configured to operate or control operation of the fluid source. The control unit may be configured to operate the fluid source based on a fluid source criterion, such as whether or not oxygen content in the ballast water is below a threshold value, such as an oxygen threshold value. The fluid source criterion may comprise whether a gas content, such as carbondioxide or nitrogen in the ballast water is above a threshold. The fluid source criterion may be based on oxygen content indicated by a sensor output.

The control unit may be configured to operate or control operation of the pump unit and the fluid source based on both the pump criterion and the fluid source criterion. For example, if the pump criterion is fulfilled and the fluid source criterion is not fulfilled, the pump speed may be reduced and/or the addition of fluid may be increased. If both the pump criterion and the fluid source criterion are fulfilled, the pump speed may be reduced, e.g. to less than 5%, and the addition of fluid may be reduced or stopped.

The control unit may be configured to operate or control operation of the circulation system and/or elements of the circulation system, such as the pump unit, the fluid source, and/or the water treatment unit. The control unit may comprise a user interface configured for obtaining user input. The control unit may be configured to operate the circulation system and/or elements of the circulation system, such as the pump unit, the fluid source, and/or the water treatment unit, based on the obtained user input.

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

Throughout, the same reference numerals are used for identical or corresponding parts.

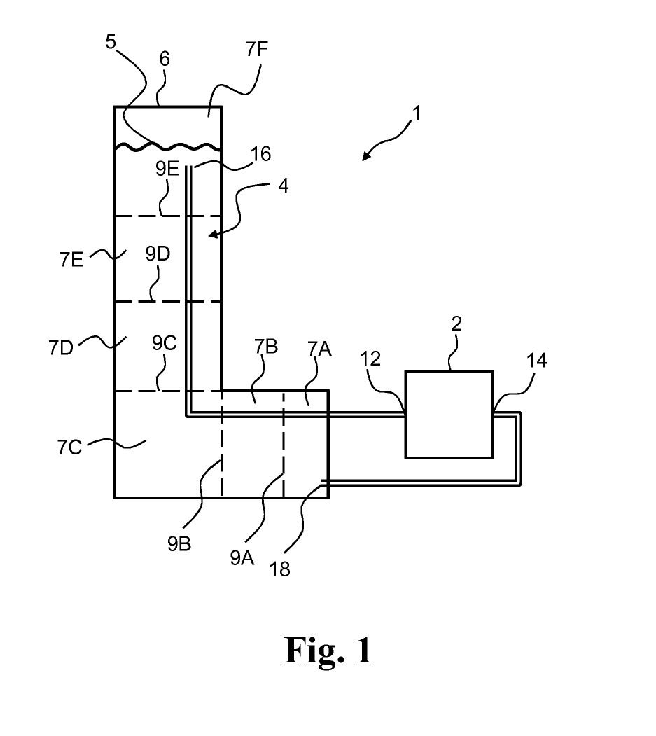

FIG. 1 schematically illustrates an exemplary ballast water system 1. The ballast water system 1 comprises a circulation system 2 and a ballast tank 6.

The ballast tank 6 has a tank inlet 18 and a tank outlet 16. The tank inlet 18 is positioned below the tank outlet 16, e.g. tank inlet 18 may be at the lower part of the ballast tank 6, and/or the tank outlet 16 may be at the upper part of the ballast tank 6. The tank outlet 16 may be configured to effectively be in the vicinity of the surface of the ballast water 4. For example, the tank outlet 16 may have a plurality of vertically distributed openings (not shown) inside the ballast tank 6.

The circulation system 2 is connected to the ballast tank 6. The circulation system 2 is configured to handle ballast water 4 of the ballast tank 6. The ballast water 4 at least partly fills the ballast tank 6 to a ballast water level 5. The circulation system 2 comprises a first system inlet 12 and a first system outlet 14. The first system inlet 12 is coupled to the tank outlet 16 and the first system outlet 14 is coupled to the tank inlet 18.

In FIG. 1 the circulation system 2 is depicted and describes as being configured to handle ballast water 4 of the ballast tank 6. However, the circulation system 2 may be configured to handle ballast water 4 of one or more ballast tanks, e.g. including the ballast tank 6.

FIG. 1 illustrates a first section of the ballast tank 6, the first section comprising a plurality of compartments (e.g. five or more) 7A, 7B, 7C, 7D, 7E, 7F, separated by respective compartment walls 9A, 9B, 9C, 9C, 9E. Ballast tanks such as the ballast tank 6 may be L-shaped, as depicted, or alternatively, the ballast tank may be I-shaped or U-shaped.

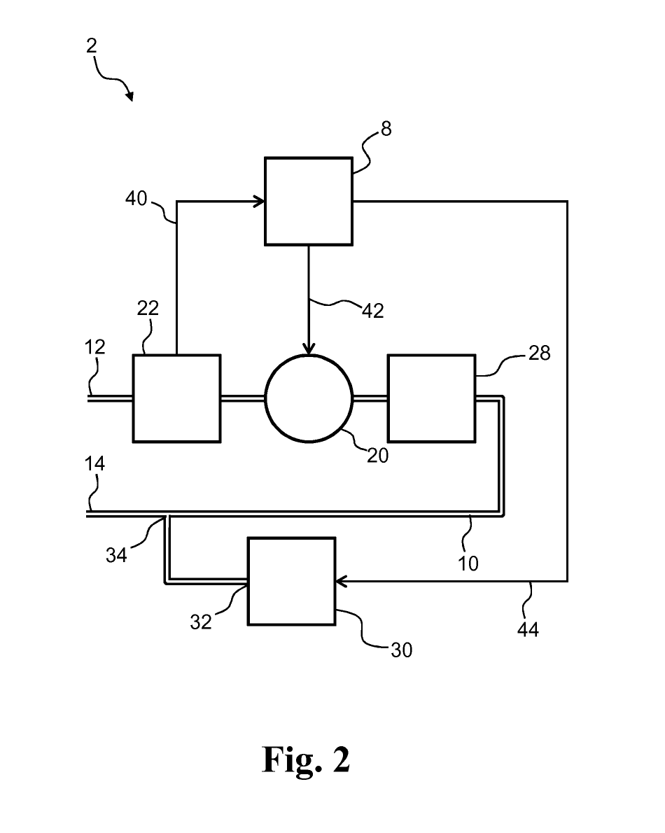

FIG. 2 schematically illustrates an exemplary circulation system 2 for handling ballast water, e.g. ballast water of one or more ballast tanks, as illustrated and described in relation to FIG. 1.

The circulation system 2 comprises a control unit 8, a pipe structure 10, and a pump unit 20.

The pipe structure 10 has a first system inlet 12 and a first system outlet 14. The first system inlet 12 is configured for fluid communication with a tank outlet of the one or more ballast tanks, and the first system inlet 12 is configured for supplying ballast water to the circulation system 2. The first system outlet 14 is configured for fluid communication with a tank inlet of the one or more ballast tanks, and the first system outlet is configured for supplying ballast water to the one or more ballast tanks.

The pump unit 20, e.g. a circulation pump, is configured for pumping ballast water between the first system inlet 12 and the first system outlet 14. The pump unit is connected to the control unit 8. The pump unit 20 may be configured to pump up to 500 m3 ballast water per hour or more.

The control unit 8 is configured to obtain a volume parameter indicative of pumped volume. For example, the control unit 8 may be configured to estimate pumped volume from duration of operation of the circulation system 2 and/or duration of operation of the pump unit 20 and/or pump speed of the pump unit 20. Alternatively or additionally, the circulation system 2 may comprise a sensor unit 22, which is further described below, and the control unit 8 may obtain the volume parameter based on sensor output 40.

The control unit 8 is further configured to determine if a pump criterion is fulfilled. The pump criterion is based on the volume parameter obtained. For example, the pump criterion may comprise comparing pumped volume and a threshold value. The threshold value may be a function, such as a multiplication, of ballast water volume in the one or more ballast tanks. For example, the threshold value may be between 1 and 10 times the ballast water volume in the one or more ballast tanks, e.g. 6 times the ballast water volume in the one or more ballast tanks.

The control unit 8 is further configured to operate the pump unit 20. The control unit 8 is configured to operate the pump unit 20 based on whether the pump criterion is fulfilled or not. For example, the control unit 8 may be configured to reduce pump speed of the pump unit 20 if the pump criterion or a subcriterion therof is fulfilled, e.g. the control unit 8 may be configured to reduce flow through the pipe structure 10 if the pump criterion is fulfilled. Alternatively or additionally, the control unit 8 may be configured to increase pump speed and/or maintain pump speed if the pump criterion is not fulfilled. The control unit 8 transmits a pump control signal 42 to the pump unit 20. The pump unit 20 is configured to receive the pump control signal 42 and operate accordingly. For example, the pump control signal 42 may be indicative of pump speed, and the pump unit 20 may adjust pump speed in accordance with pump speed indicated by the pump control signal 42.

The circulation system 2 comprises an optional sensor unit 22, an optional water treatment unit 28, and/or an optional fluid source 30.

The sensor unit 22 is connected to the control unit 8, and the sensor unit 22 is configured for providing a sensor output 40 to the control unit 8. The sensor unit 22 may be an integrated part of the pump unit 20. For example, the sensor output 40 may comprise data indicative of the speed of the pump and/or flow of water through the pump.

The control unit 8 may be configured to obtain the volume parameter indicative of pumped volume based on the sensor output 40. For example, the sensor output 40 may be indicative of flow of water through the pump, and the control unit is configured to calculate and/or estimate the volume parameter from the sensor output 40. Alternatively, the sensor output 40 may be indicative of volume and/or flow of water through the pipe during a period of time. Alternatively or additionally, the sensor output 40 may comprise data indicative of oxygen content and/or other gas content in the ballast water, and the control unit 8 may be configured to obtain an oxygen parameter indicative of oxygen content in the ballast water.

The water treatment unit 28 treats ballast water between the first system inlet 12 and the first system outlet 14. The water treatment unit 28 is configured to reduce or eliminate live organisms in the ballast water. For example, the water treatment unit 28 may add chemicals to the ballast water. Additionally or alternatively, the water treatment unit 28 may provide heat treatment of the ballast water.

The fluid source 30 may add a gas and/or a liquid and/or a combination of a gas and a liquid to the ballast water. For example, addition of gas, such as nitrogen, may facilitate depletion of oxygen in the ballast water. Addition of a gas, such as nitrogen, may aid to stirring or mixing the ballast water in the one or more ballast tanks. Thereby, the ballast water is homogenous, or roughly homogenous, in the one or more ballast tanks and/or in each compartment of the one or more ballast tanks. The fluid source 30 has a fluid outlet 32 connected to a fluid inlet 34 of the pipe structure 10. The fluid inlet 34 of the pipe structure 10 is positioned downstream the pump unit 20.

In another exemplary circulation system (not shown) the fluid source 30 has a fluid inlet connected to a fluid outlet of the pipe structure 10. Hence, a fraction, e.g. 5%, of the ballast water in the pipe structure flows through the fluid source 30, and fluid, such as a gas, a liquid, and/or a combination of gas and liquid may be added to the fraction of ballast water flowing through the fluid source 30.

The control unit 8 is optionally configured to determine if a fluid source criterion is fulfilled. The fluid source criterion is based on the oxygen parameter obtained. For example, the fluid source criterion may comprise comparing oxygen content in the ballast water and an oxygen threshold value.

The control unit 8 may be configured to operate the pump unit 20 and/or the fluid source 30 based on whether the pump criterion and/or the fluid source criterion are fulfilled or not. For example, the control unit 8 may operate the fluid source 30 to increase fluid addition if the pump criterion is fulfilled and the fluid criterion is not fulfilled. Alternatively or additionally, the control unit 8 may operate the fluid source 30 to reduce fluid addition if both the pump criterion and the fluid criterion are fulfilled.

The control unit 8 transmits a fluid source control signal 44 to the fluid source 30. The fluid source 30 is configured to receive the fluid source control signal 44 and operate accordingly. For example, the fluid source control signal 44 may be indicative of fluid addition speed, and the fluid source 30 may adjust fluid addition speed in accordance with fluid addition speed indicated by the fluid source control signal 44.

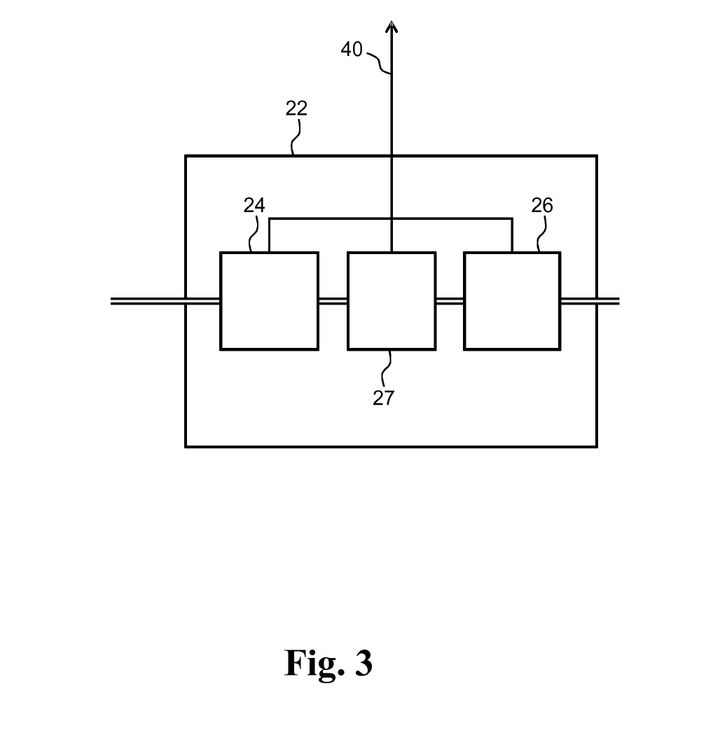

FIG. 3 schematically illustrates an exemplary sensor unit 22. The sensor unit 22 comprises a flow sensor 24, a volume sensor 26, and a gas sensor 27. The flow sensor 24 measures ballast water flow through the circulation system. The volume sensor 26 measures ballast water volume through the circulation system. The gas sensor 27 may be an oxygen sensor that measures oxygen content in the ballast water.

The volume sensor 26 may be configured to continuously measure ballast water volume, and/or the volume sensor 26 may be configured to reset the measured ballast water volume, e.g. when circulation of ballast water is initiated and/or when the ballast tank is filled or emptied.

It is emphasized that a sensor unit, such as the sensor unit 22, may comprise both a flow sensor, a volume sensor, and an oxygen sensor (as illustrated). Alternatively, a sensor unit may comprise one or more of a flow sensor 24, a volume sensor 26 and a gas sensor 27. Consequently, the sensor output 40 is indicative of ballast water flow, pumped water volume, and/or gas content, such as oxygen, nitrogen, and/or carbondioxide content in the ballast water.

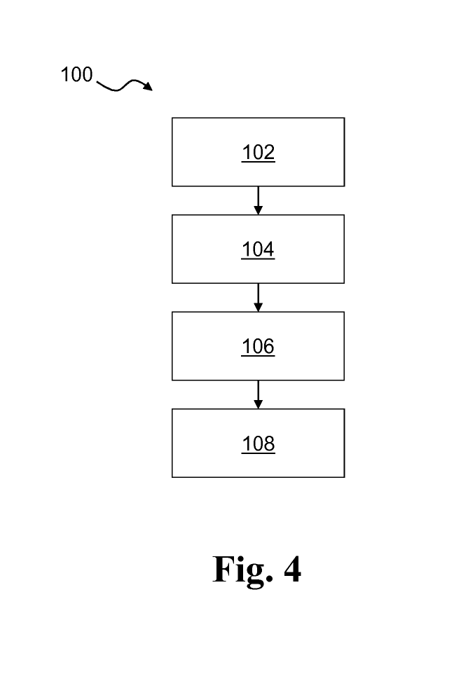

FIG. 4 is a flow chart of an exemplary method 100 for handling ballast water of one or more ballast tanks. The method 100 comprising: pumping 102 ballast water, obtaining 104 a volume parameter, determining 106 if a pump criterion is fulfilled, and operating 108 a pump unit.

Pumping 102 ballast water comprises pumping 102 ballast water in a pipe structure between a tank outlet and a tank inlet with a pump unit. The tank outlet is a tank outlet of the one or more ballast tanks. The tank inlet is a tank inlet of the one or more ballast tanks.

Obtaining 104 a volume parameter comprises obtaining 104 a volume parameter indicative of pumped volume, e.g. pumped volume of ballast water through the pipe structure and/or the pump unit.

Determining 106 if a pump criterion is fulfilled comprises determining 106 if a pump criterion is fulfilled, wherein the pump criterion is based on the volume parameter. For example, the pump criterion may comprise comparing pumped volume and a threshold value, such as a volume threshold, e.g. the pump criterion may be determined 106 to be fulfilled if the pumped volume is greater than the threshold value.

Operating 108 the pump unit comprises operating 108 the pump unit based on whether the pump criterion is fulfilled or not. For example, the pump unit may be operated 108 to reduce pump speed if the pump criterion is fulfilled.

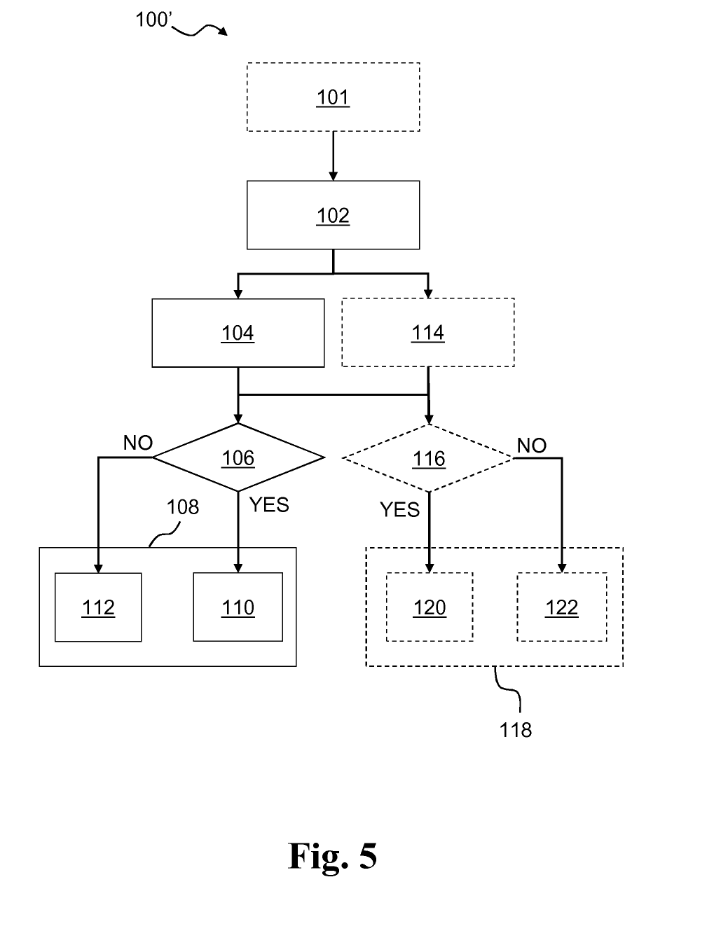

FIG. 5 is a flow chart of an exemplary method 100′ for handling ballast water. The method 100′ comprises the same steps as the method 100 as illustrated in FIG. 4. However, it is further exemplified how determining 106 if a pump criterion is fulfilled leads to difference in operating 108 the pump unit. If the pump criterion is determined 106 to be fulfilled the pump speed is reduced 110. If on the contrary, the pump criterion is determined 106 not to be fulfilled the pump speed is maintained 112.

The method 100′ also shows an optional step of obtaining 101 ballast water volume data. The ballast water volume data is indicative of ballast water volume of the one or more ballast tanks. For example, the one or more ballast tanks may be filled to 50%, and the ballast water volume data indicative of the ballast water volume may be obtained, e.g. by an operator typing on a control panel a percentage of filling and/or an absolute volume, alternatively or additionally, the ballast water volume data may be obtained from sensors in the ballast tank and/or a central vessel computer.

The method 100′ also shows an optional step of obtaining 114 an oxygen parameter, e.g. indicative of the amount of oxygen content in the ballast water. Determining 106 if the pump criterion is fulfilled may comprise determining 106 if a pump criterion is fulfilled, wherein the pump criterion is based on the oxygen parameter. For example, the pump criterion may comprise comparing oxygen content in the ballast water with an oxygen threshold value, e.g. the pump criterion may be determined 106 to be fulfilled if oxygen content in the ballast water is less than the oxygen threshold value and/or if the pump volume is greater than the volume threshold value.

The method 100′ also shows an optional step of determining 116 if a fluid source criterion is fulfilled. The fluid source criterion is based on the oxygen parameter. For example, the oxygen criterion may comprise comparing oxygen content in the ballast water with an oxygen threshold value, e.g. the fluid source criterion may be fulfilled if oxygen content in the ballast water is less than the oxygen threshold value. Alternatively or additionally, the fluid source criterion is based on the volume parameter. For example, the fluid source criterion may comprise comparing pumped volume and a threshold value, such as a volume threshold, e.g. the fluid source criterion may be determined 116 to be fulfilled if the pumped volume is greater than the threshold value and/or if oxygen content in the ballast water is less than the oxygen threshold value.

The method 100′ also exemplifies operating 118 a fluid source based on whether the fluid source criterion is fulfilled or not. For example if the fluid source criterion is determined 116 to be fulfilled the fluid source is operated 118 to reduce 120 addition of fluid. If on the contrary, the fluid source criterion is determined 116 not to be fulfilled the fluid source is operated 118 to maintain 122 addition of fluid.

It should be emphasized, that the pump criterion and/or the fluid source criterion in an exemplary method may be combinations of oxygen content in the ballast water and pumped volume. For example, if the pumped volume is above a volume threshold and the oxygen content is not below an oxygen threshold the pump speed may be reduced and the addition of fluid may be increased. Alternatively or additionally, if the pumped volume is above a volume threshold and the oxygen content is below an oxygen threshold, the pump speed may be reduced and the addition of fluid may be reduced, e.g. the circulation system may be shut off or proceed to an idle state.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications and equivalents.

### LIST OF REFERENCES

1 ballast water system
2 circulation system
4 ballast water
5 ballast water level
6 ballast tank
7A first compartment
7B second compartment
7C third compartment
7D fourth compartment
7E fifth compartment
7F sixth compartment
8 control unit
9A first compartment wall
9B second compartment wall
9C third compartment wall
9D fourth compartment wall
9E fifth compartment wall
10 pipe structure
12 first system inlet
14 first system outlet
16 tank outlet
18 tank inlet
20 pump unit
22 sensor unit
24 flow sensor
26 volume sensor
27 gas sensor
28 water treatment unit
30 fluid source
32 fluid outlet
34 fluid inlet
40 sensor output
42 pump control signal
44 fluid source control signal
100, 100′ method
101 obtaining ballast water volume data
102 pumping ballast water
104 obtaining volume parameter
106 determining pump criterion
108 operating pump unit
110 reduce pump speed
112 maintaining pump speed
114 obtaining oxygen parameter
116 determining fluid source criterion
118 operating fluid source
120 reduce addition of fluid
122 maintain addition of fluid

1. A circulation system for handling ballast water of one or more ballast tanks, the circulation system comprising:
a control unit;
a pipe structure having a first system inlet and a first system outlet, the first system inlet being configured for fluid communication with a tank outlet of the one or more ballast tanks for supplying ballast water to the circulation system, and the first system outlet being configured for fluid communication with a tank inlet of the one or more ballast tanks for supplying ballast water to the one or more ballast tanks; and
a pump unit for pumping ballast water between the first system inlet and the first system outlet, wherein the pump unit is connected to the control unit;
wherein the control unit is configured to:
obtain a volume parameter indicative of pumped volume;
determine if a pump criterion is fulfilled, wherein the pump criterion is based on the volume parameter; and
operate the pump unit based on whether the pump criterion is fulfilled or not.

2. The circulation system according to claim 1, wherein the control unit is configured to obtain ballast water volume data indicative of ballast water volume in the one or more ballast tanks, and wherein the pump criterion is based on ballast water volume.

3. The circulation system according to claim 1, wherein to determine if a pump criterion is fulfilled comprises to compare pumped volume and a threshold value.

4. The circulation system according to claim 3, wherein the threshold value is a function of ballast water volume in the one or more ballast tanks.

5. The circulation system according to claim 4, wherein the threshold value is given as a multiplication factor times ballast water volume in the one or more ballast tanks.

6. The circulation system according to claim 3, wherein the threshold value is between 1 to 10 times ballast water volume in the one or more ballast tanks.

7. The circulation system according to claim 1, wherein the circulation system further comprises a sensor unit connected to the control unit for providing a sensor output to the control unit, and wherein the volume parameter indicative of pumped volume is based on the sensor output.

8. The circulation system according to claim 7, wherein the sensor unit comprises a flow sensor measuring ballast water flow through the circulation system, and wherein the sensor output is indicative of ballast water flow.

9. The circulation system according to claim 7, wherein the sensor unit comprises a volume sensor measuring ballast water volume through the circulation system, and wherein the sensor output is indicative of pumped ballast water volume.

10. The circulation system according to claim 1, wherein the circulation system further comprises a water treatment unit for treating ballast water between the first system inlet and the first system outlet.

11. The circulation system according to claim 1, wherein the circulation system further comprises a fluid source having a fluid outlet connected to a fluid inlet of the pipe structure, wherein the fluid source is connected to the control unit, and wherein the control unit is configured to operate the fluid source.

12. The circulation system according to claim 11, wherein the fluid inlet is positioned downstream the pump unit.

13. The circulation system according to claim 1, wherein the control unit is configured to reduce a pump speed when the pump criterion is fulfilled.

14. A ballast water system comprising a circulation system according to claim 1 and a ballast tank having a tank inlet at the lower part of the ballast tank and a tank outlet at the upper part of the ballast tank, wherein the first system inlet is coupled to the tank outlet and the first system outlet is coupled to the tank inlet.

15. A control unit for a circulation system for handling ballast water of one or more ballast tanks, the circulation system comprising a pump unit pumping ballast water in a pipe structure between a tank outlet and a tank inlet, wherein the control unit is configured to:
obtain a volume parameter indicative of pumped volume;
determine if a pump criterion is fulfilled, wherein the pump criterion is based on the volume parameter; and
operate the pump unit based on whether the pump criterion is fulfilled or not.

16. A method for handling ballast water of one or more ballast tanks, the method comprising:
pumping ballast water in a pipe structure between a tank outlet and a tank inlet with a pump unit;
obtaining a volume parameter indicative of pumped volume;
determining if a pump criterion is fulfilled, wherein the pump criterion is based on the volume parameter; and
operating the pump unit based on whether the pump criterion is fulfilled or not.
